(19) United States
(12) Patent Application Publication
(10) Pub. No.: US 2022/0284846 A1
(43) Pub. Date: Sep. 8, 2022

(54) METHOD AND APPARATUS FOR ADJUSTING DISPLAY BRIGHTNESS, ELECTRONIC DEVICE, AND STORAGE MEDIUM

(71) Applicant: ONEPLUS TECHNOLOGY (SHENZHEN) CO., LTD., Shenzhen (CN)

(72) Inventor: Shoufei Miao, Shenzhen (CN)

(21) Appl. No.: 17/826,824

(22) Filed: May 27, 2022

Related U.S. Application Data
(63) Continuation of application No. PCT/CN2020/121192, filed on Oct. 15, 2020.

(30) Foreign Application Priority Data
Nov. 27, 2019 (CN) 201911181515.5

(51) Int. Cl. G09G 3/20

(52) U.S. Cl. CPC G09G 3/2059; G09G 2320/043; G09G 2320/0666; G09G 2320/0242; G09G 2340/06; G09G 2360/16

(57) ABSTRACT

Provided are a method and apparatus for adjusting display brightness, an electronic device, and a storage medium. The method includes: obtaining (S202) a target brightness value and a color value of each pixel in loaded pixel data to be displayed; adjusting (S204) the color value of each pixel, based on the target brightness value, to obtain the adjusted color value; and performing error diffusion processing on the adjusted color value to obtain an error-diffusion processed color value, and displaying the loaded pixel data to be displayed using the error-diffusion processed color value (S206). The color value of each pixel is adjusted using the target brightness value, the brightness can be adjusted without lighting and blanking the screen and independently of the hardware; and error diffusion processing is performed on the adjusted color value to avoid the problems of color bands and color blocks caused by adjusting the color value.

### CROSS-REFERENCE TO RELATED APPLICATIONS

This application is a continuation of International Application No. PCT/CN2020/121192, filed on Oct. 15, 2020, which claims priority to Chinese Patent Application No. 201911181515.5, filed on Nov. 27, 2019. The disclosures of the aforementioned applications are hereby incorporated by reference in their entireties.

### FIELD

The present application relates to the technical field of mobile smart terminals, and more particularly, to a method for adjusting brightness, an apparatus for adjusting brightness, an electronic device, and a storage medium.

### BACKGROUND

With the development of science and technology, mobile smart terminals such as smart phones, tablets and other devices are widely applied in and provide convenience for people's lives. When the user uses an application on the terminal in different environments, it may be necessary to adjust display brightness of the application. For example, when the user uses the application on the terminal in a weak ambient light, it will be harmful to the user's eyesight if the display brightness of the application is not lowered at this time.

In the convention methods for adjusting display brightness, pulse width modulation is widely used to adjust light, and brightness is adjusted through fast flickering. When using the pulse width modulation light-adjusting technology to adjust the display brightness, the brightness adjustment depends on a lighting-blanking alternation of the screen. When the screen is lighted, instead of continuously emitting light, the screen is constantly lighted and blanked. When the lighting-blanking alternation is fast enough, the naked eyes would feel that the terminal is always on. In the process of lighting and blanking the screen, if the blanked state of the screen lasts longer, the naked eyes would feel lower brightness of the screen, and if the lighted state of the screen lasts longer and the blanked time is correspondingly shortened, the screen becomes brighter.

However, the conventional methods for adjusting the brightness by lighting and blanking the screen requires the cooperation of the hardware devices in the display device to be continuously lighted and blanked, which greatly shortens the service life of the hardware devices and seriously affects the service life of the entire display device.

### SUMMARY

Based on this, it is necessary to provide a method for adjusting display brightness, an apparatus for adjusting display brightness, an electronic device and a storage medium, in which the brightness is not adjusted by lighting and blanking the screen, so as to prolong the service life of the display device.

A method for adjusting display brightness includes: obtaining a target brightness value and a color value of each pixel in loaded pixel data to be displayed; adjusting the color value of each pixel, based on the target brightness value, to obtain the adjusted color value; and performing error diffusion processing on the adjusted color value to obtain an error-diffusion processed color value, and displaying the loaded pixel data to be displayed by using the error-diffusion processed color value.

In an embodiment, said performing the error diffusion processing on the adjusted color value to obtain the error-diffusion processed color value includes: obtaining the adjusted color value of the pixel and coordinate values of the pixel; processing the coordinate values of the pixel based on a triangular noise algorithm to generate a quantization error corresponding to the pixel; and superimposing the quantization error on the adjusted color value of the pixel to obtain the error-diffusion processed color value of the pixel.

In an embodiment, said adjusting the color value of each pixel, based on the target brightness value, to obtain the adjusted color value includes: converting the color value of each pixel from a red, green and blue color space to a hue, saturation and brightness color space; multiplying a brightness component in a color space-converted color value of each pixel by the target brightness value to obtain a brightness-adjusted color value of each pixel; and converting the brightness-adjusted color value of each pixel from the hue, saturation and brightness color space to the red, green and blue color space to obtain a brightness-adjusted color value of each pixel in the red, green and blue color space.

In an embodiment, said obtaining the color value of each pixel in the loaded pixel data to be displayed includes: when the loaded pixel data to be displayed comprises pixel data corresponding to an image, dividing the image into a plurality of image blocks, and obtaining a color value of each pixel in each of the plurality of image blocks respectively.

In an embodiment, prior to said obtaining the color value of each pixel in the loaded pixel data to be displayed, the method further includes: when pixel data that is to be displayed and is drawn by two or more mobile terminal applications is received, performing synthesis processing on the pixel data that is to be displayed and is drawn by each of the two or more mobile terminal applications to obtain synthesized pixel data. Said obtaining the color value of each pixel in the loaded pixel data to be displayed includes: obtaining a color value of each pixel in the synthesized pixel data.

An apparatus for adjusting display brightness includes: a color value obtaining module configured to obtain a target brightness value and a color value of each pixel in loaded pixel data to be displayed; a color adjustment module configured to adjust the color value of each pixel, based on the target brightness value, to obtain the adjusted color value; and an error processing module configured to perform error diffusion processing on the adjusted color value to obtain an error-diffusion processed color value, and display the loaded pixel data to be displayed by using the error-diffusion processed color value.

An electronic device includes a memory and a processor. The memory has a computer program stored thereon. The processor executes the computer program to implement the following actions: obtaining a target brightness value and a color value of each pixel in loaded pixel data to be displayed; adjusting the color value of each pixel, based on the target brightness value, to obtain the adjusted color value; and performing error diffusion processing on the adjusted color value to obtain an error-diffusion processed color value, and displaying the loaded pixel data to be displayed by using the error-diffusion processed color value.

Provided is a computer-readable storage medium having a computer program stored thereon. When the computer program is executed by a processor, the following actions are implemented: obtaining a target brightness value and a color value of each pixel in loaded pixel data to be displayed; adjusting the color value of each pixel, based on the target brightness value, to obtain the adjusted color value; and performing error diffusion processing on the adjusted color value to obtain an error-diffusion processed color value, and displaying the loaded pixel data to be displayed by using the error-diffusion processed color value.

### BRIEF DESCRIPTION OF DRAWINGS

FIG. 1a is a schematic diagram illustrating an application environment of a method for adjusting display brightness according to an embodiment.

FIG. 1B is a schematic diagram illustrating an application environment of a method for adjusting display brightness according to an embodiment.

FIG. 2 is a schematic flowchart of a method for adjusting display brightness according to an embodiment.

FIG. 3 is a schematic flowchart of actions of error diffusion processing according to an embodiment.

FIG. 4 is a structural block diagram of an apparatus for adjusting display brightness according to an embodiment.

FIG. 5 is a schematic diagram of an internal structure of an electronic device according to an embodiment.

### DESCRIPTION OF EMBODIMENTS

In order to explain the purpose, technical solutions and advantages of the present disclosure, the present disclosure will be described in detail below with reference to the accompanying drawings and embodiments. It should be understood that the specific embodiments described herein are only used to explain the present disclosure, but not to limit the present disclosure.

FIG. 1a is a schematic diagram illustrating an application environment of a method for adjusting display brightness according to an embodiment. Referring to FIG. 1a, the application scenario includes a terminal processor 102 and a terminal display assembly 104, and the terminal processor 102 and the terminal display assembly 104 are connected through an interface. The terminal processor 102 can send data to the terminal display assembly 104 through the interface, so as to control the terminal display assembly to display. The terminal processor 102 obtains a target brightness value, and a color value of each pixel in loaded pixel data to be displayed; adjusts the color value of each pixel based on the target brightness value, to obtain the adjusted color value; and performs error diffusion processing on the adjusted color value to obtain an error-diffusion processed color value. The loaded pixel data to be displayed is displayed by using the error-diffusion processed color value. For example, the terminal processor 102 sends the error-diffusion processed color value to the terminal display assembly 104, and the terminal display assembly 104 displays based on the error-diffusion processed color value.

In another application scenario, as illustrated in FIG. 1B, a terminal 106 communicates with a server 108 through network. The server 108 obtains, from the terminal 106, a target brightness value, and a color value of each pixel in loaded pixel data to be displayed; adjusts the color value of each pixel based on the target brightness value, to obtain the adjusted color value; and performs error diffusion processing on the adjusted color value to obtain an error-diffusion processed color value, and displays the loaded pixel data to be displayed by using the error-diffusion processed color value. The terminal 106 can be, but is not limited to, various personal computers, notebook computers, smart phones and tablet computers, and the server 108 can be an independent server or a server cluster composed of a plurality of servers.

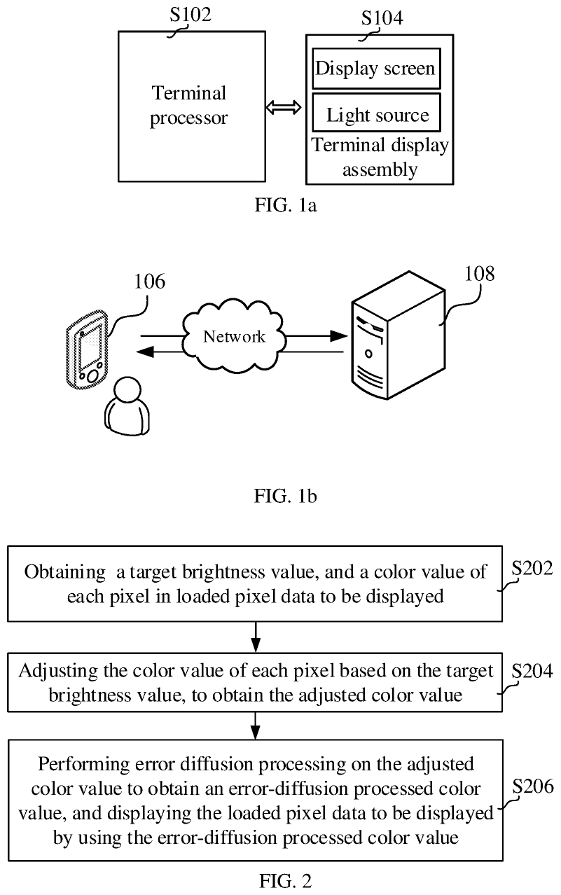

In an embodiment, as illustrated in FIG. 2, a method for adjusting display brightness is provided. As an example, the method is applied in the terminal processor/server illustrated in FIG. 1, for the purpose of illustration, and the method includes the following actions at blocks.

At block 202: a target brightness value and a color value of each pixel in loaded pixel data to be displayed are obtained.

The user can input the target brightness value through a control corresponding to a brightness setting item on the mobile terminal. For example, when the user needs to reduce the display brightness, the user can input the target brightness value to be reduced through the setting item control. The loaded pixel data to be displayed refers to pixel data to be displayed that is loaded by a mobile terminal application, and specifically, the pixel data may include a plurality of different pixels each corresponding to a different color value, for obtaining the color value of each pixel.

At block 204: the color value of each pixel is adjusted based on the target brightness value to obtain the adjusted color value.

For example, the user needs to reduce the display brightness, and the target brightness value of 0.1 is obtained. In this case, the color value of each pixel is multiplied by 0.1 to adjust the color value of each pixel. As an example, if the color value of a certain pixel is (255, 154, 151), the color value of the pixel is adjusted by using the target brightness value of 0.1 to obtain the color value (25.5, 15.4, 15.1), and the adjusted color value (26, 15, 15) is obtained in accordance with the rounding principle.

At block 206: error diffusion processing is performed on the adjusted color value to obtain an error-diffusion processed color value, and the loaded pixel data to be displayed is displayed by using the error-diffusion processed color value.

As mentioned above, before the color value of the pixel is adjusted, there is a difference between the color components 154 and 151. After the color value of the pixel is adjusted, the two color components are both 15 and have no difference therebetween, which is inconsistent with the actual situation. The loss of color accuracy results in indistinct color distinction, resulting in problems such as color bands and color blocks. Therefore, it is necessary to perform the error diffusion processing on the adjusted color value to avoid the occurrence of color bands and color blocks.

In the above-mentioned method for adjusting display brightness, the target brightness value and the color value of each pixel in the loaded pixel data to be displayed are obtained, and based on the target brightness value, the color value of each pixel is adjusted, such that the brightness can be adjusted without lighting and blanking the screen, i.e., the brightness can be adjusted independently of hardware. Further, the error diffusion processing is performed on the adjusted color value to obtain the error-diffusion processed color value, and the loaded pixel data to be displayed is displayed by using the error-diffusion processed color value, so as to avoid the problems of color bands and color blocks caused by adjusting the color value. Such a brightness adjustment method does not need to control the screen to be lighted and blanked continuously, and the service life of the hardware devices can be ensured independently of hardware, thereby prolonging the service life of the entire display device.

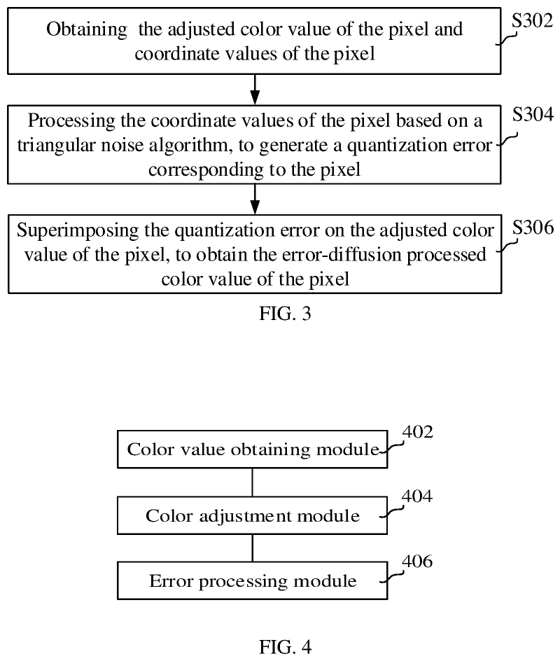

In an embodiment, as illustrated in FIG. 3, said performing the error diffusion processing on the adjusted color value to obtain the error-diffusion processed color value includes: an action at block 302 of obtaining the adjusted color value of the pixel and coordinate values of the pixel; an action at block 304 of processing the coordinate values of the pixel based on a triangular noise algorithm to generate a quantization error corresponding to the pixel; and an action at block 306 of superimposing the quantization error on the adjusted color value of the pixel to obtain the error-diffusion processed color value of the pixel. As an example, the adjusted color value of a certain pixel is (25, 0, 0), the coordinate values of the pixel are (x1, y1), a screen size can be expressed as (x2, y2) in the form of coordinates, and a noise vector corresponding to the pixel is constructed as n=(x1, y1)*(x2, y2)/255. Vector p=fract(n*(5.3987, 5.4421)), where the function of fract is to take the fractional part of the result, p=p+dot(p.yx, p.xy+(21.5351, 14.3137)), where dot represents dot product. When the coordinates of p are (x, y), p.yx=(y, x), p.xy=(x, y). In this case, the quantization error result=fract(xy*95.4307)+fract(xy*75.0961)−1.0, and the error-diffusion processed color value of the pixel is (25+result, result, result).

In an embodiment, said adjusting the color value of each pixel based on the target brightness value, to obtain the adjusted color value includes: splitting the color value of each pixel into corresponding red, green and blue color components; multiplying each of the red, green and blue color components of each pixel by the target brightness value, to obtain brightness-adjusted red, green and blue color components; and recombining the brightness-adjusted red, green and blue color components to obtain a brightness-adjusted color value. For example, the color value of a certain pixel is 0xCCCCCC, and the corresponding red, green, and blue color components are 0xCC, 0xCC, and 0xCC, respectively. These three color components are each multiplied by the target brightness value set by the user, for example, 0.5, to obtain the brightness-transformed color components 0x66, 0x66, and 0x66. The color components 0x66, 0x66, and 0x66 are recombined to obtain the brightness-transformed color value 0x666666. In this way, without requiring the terminal to support the alpha channel, the brightness can be changed by means of a translucent mask.

In an embodiment, said adjusting the color value of each pixel based on the target brightness value, to obtain the adjusted color value includes: converting the color value of each pixel from a red, green and blue color space to a hue, saturation and brightness color space; multiplying a brightness component in a color space-converted color value of each pixel by the target brightness value to obtain a brightness-adjusted color value of each pixel; and converting the brightness-adjusted color value of each pixel from the hue, saturation and brightness color space to the red, green and blue color space, to obtain a brightness-adjusted color value of each pixel in the red, green and blue color space. By performing the color space conversion and adjusting the brightness by directly adjusting the brightness components in the color value, the brightness adjustment effect is better.

In an embodiment, said obtaining the color value of each pixel in the loaded pixel data to be displayed includes: when the loaded pixel data to be displayed includes pixel data corresponding to an image, dividing the image into a plurality of image blocks, and obtaining the color value of each pixel in each of the plurality of image blocks respectively. By dividing the initial image to be displayed into the plurality of image blocks, and employing the method for adjusting display brightness on each image block, these image blocks can be processed in parallel, thereby enhancing the real-time processing capability.

In an embodiment, prior to said obtaining the color value of each pixel in the loaded pixel data to be displayed, the method further includes: in response to receiving pixel data to be displayed that is drawn by two or more mobile terminal applications, performing synthesis processing on the pixel data to be displayed that is drawn by each of the two or more mobile terminal applications, to obtain synthesized pixel data. In addition, said obtaining the color value of each pixel in the loaded pixel data to be displayed includes: obtaining the color value of each pixel in the synthesized pixel data. Specifically, the pixel data to be displayed of a plurality of mobile terminal applications can be synthesized into a piece of pixel data by Open Graphics Library (OpenGL), and the color value of each pixel in the synthesized pixel data can be obtained. The color value of each pixel is adjusted based on the target brightness value to obtain the adjusted color value, the error diffusion processing is performed on the adjusted color value, to obtain the error-diffusion processed color value, and the error-diffusion processed color value is sent to Framebuffer (Framebuffer is to drive a video display device from a memory buffer containing complete frame data through a video output device) for display.

It should be understood that, although the actions in blocks are shown in a certain sequence indicated by the arrows in the flowcharts of FIG. 2 and FIG. 3, these actions in blocks are not necessarily performed in the sequence as indicated by the arrows. Unless explicitly stated herein, these actions in blocks may not be strictly performed in a limited order, and they can be performed in other orders. Moreover, at least some actions in blocks in FIG. 2 and FIG. 3 may include a plurality of sub-actions or a plurality of stages. These sub-actions or stages are not necessarily performed and completed at the same time, but they may be performed at different times. The order of performance of the sub-actions or stages is not necessarily in sequence, but may be performed alternately with other actions or at least some sub-actions or stages of other actions.

In an embodiment, as illustrated in FIG. 4, an apparatus for adjusting display brightness is provided. The apparatus includes a color value obtaining module 402, a color adjustment module 404, and an error processing module 406. The color value obtaining module is configured to obtain a target brightness value, and a color value of each pixel in loaded pixel data to be displayed. The color adjustment module is configured to adjust the color value of each pixel based on the target brightness value, to obtain the adjusted color value. The error processing module is configured to perform error diffusion processing on the adjusted color value to obtain an error-diffusion processed color value, and display the loaded pixel data to be displayed by using the error-diffusion processed color value.

In an embodiment, the error processing module includes: a coordinate value obtaining unit configured to obtain the adjusted color value of the pixel and coordinate values of the pixel; a quantization error generation unit configured to process the coordinate values of the pixel based on a triangular noise algorithm, to generate a quantization error corresponding to the pixel; and a superimposing unit configured to superimpose the quantization error on the adjusted color value of the pixel, to obtain the error-diffusion processed color value.

In an embodiment, the color adjustment module includes: a splitting unit configured to split the color value of each pixel into corresponding red, green and blue color components; a brightness adjustment unit configured to multiply each of the red, green and blue color components of each pixel by the target brightness value, to obtain brightness-adjusted red, green and blue color components; and a combining unit configured to recombine the brightness-adjusted red, green and blue color components to obtain a brightness-adjusted color value.

In an embodiment, the color adjustment module includes: a first color space conversion unit configured to convert the color value of each pixel from a red, green and blue color space to a hue, saturation and brightness color space; a brightness adjustment unit configured to multiply a brightness component in a color space-converted color value of each pixel by the target brightness value, to obtain a brightness-adjusted color value of each pixel; and a second color space conversion unit configured to convert the brightness-adjusted color value of each pixel from the hue, saturation and brightness color space to the red, green and blue color space to obtain a brightness-adjusted color value of each pixel in the red, green and blue color space.

In an embodiment, the color value obtaining module is further configured to, when the loaded pixel data to be displayed includes pixel data corresponding to an image: divide the image into a plurality of image blocks, and obtain the color value of each pixel in each of the plurality of image blocks respectively.

In an embodiment, the apparatus for adjusting display brightness further includes a synthesis module configured to, in response to receiving pixel data to be displayed that is drawn by two or more mobile terminal applications, perform synthesis processing on the pixel data to be displayed that is drawn by each of the two or more mobile terminal applications, to obtain synthesized pixel data; and the color value obtaining module is further configured to obtain the color value of each pixel in the synthesized pixel data.

For the specific limitations of the apparatus for adjusting display brightness, reference may be made to the limitations of the method for adjusting display brightness as described above, which will not be repeated herein. Each module in the above-mentioned apparatus for adjusting display brightness can be implemented in whole or in part by software, hardware, or a combination thereof. The above modules can be integrated in or independent of the processor in the computer device in the form of hardware, or stored in the memory in the computer device in the form of software, so that the processor can call and execute the operations corresponding to the above modules.

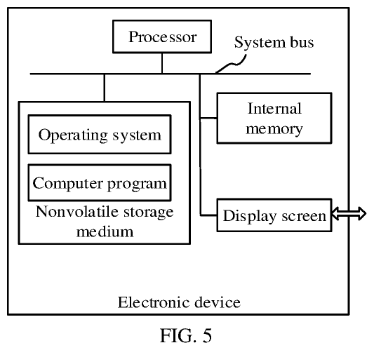

In an embodiment, an electronic device is provided. FIG. 5 is a schematic diagram of an internal structure of an electronic device. The electronic device includes a processor, a memory, and a display screen, which are connected through a system bus. The processor is configured to provide computing and control capabilities. The memory includes a non-volatile storage medium and an internal memory. The nonvolatile storage medium has an operating system and a computer program stored thereon. The internal memory provides an environment for the execution of the operating system and the computer program in the non-volatile storage medium. The method for adjusting display brightness can be implemented by the processor of the electronic device, that is, the computer program, when being executed by the processor, implements the method for adjusting display brightness.

Those skilled in the art can understand that the structure illustrated in FIG. 5 is only a block diagram of a part of the structure related to the solutions of the present disclosure, and does not constitute a limitation on the electronic device in which the solutions of the present disclosure is applied. The specific electronic device may include more or fewer components than those illustrated in the figure, or it may combine certain components or have a different arrangement of components.

In an embodiment, an electronic device is provided. The electronic device includes a memory and a processor. The memory has a computer program stored thereon, and when the processor executes the computer program, the following actions are implemented: obtaining a target brightness value, and a color value of each pixel in loaded pixel data to be displayed; adjusting the color value of each pixel based on the target brightness value, to obtain the adjusted color value; performing error diffusion processing on the adjusted color value to obtain an error-diffusion processed color value; and displaying the loaded pixel data to be displayed by using the error-diffusion processed color value.

In an embodiment, an electronic device is provided. The electronic device includes a memory and a processor. The memory has a computer program stored thereon, and when the processor executes the computer program, the following actions are implemented: obtaining the adjusted color value of the pixel and coordinate values of the pixel; processing the coordinate values of the pixel based on a triangular noise algorithm to generate a quantization error corresponding to the pixel; and superimposing the quantization error on the adjusted color value of the pixel to obtain the error-diffusion processed color value of the pixel.

In an embodiment, an electronic device is provided. The electronic device includes a memory and a processor. The memory has a computer program stored thereon, and when the processor executes the computer program, the following actions are implemented: splitting the color value of each pixel into corresponding red, green and blue color components; multiplying each of the red, green and blue color components of each pixel by the target brightness value, to obtain brightness-adjusted red, green and blue color components; and recombining the brightness-adjusted red, green and blue color components to obtain a brightness-adjusted color value.

In an embodiment, an electronic device is provided. The electronic device includes a memory and a processor. The memory has a computer program stored thereon, and when the processor executes the computer program, the following actions are implemented: converting the color value of each pixel from a red, green and blue color space to a hue, saturation and brightness color space; multiplying a brightness component in a color space-converted color value of each pixel by the target brightness value to obtain a brightness-adjusted color value of each pixel; and converting the brightness-adjusted color value of each pixel from the hue, saturation and brightness color space to the red, green and blue color space to obtain a brightness-adjusted color value of each pixel in the red, green and blue color space.

In an embodiment, an electronic device is provided. The electronic device includes a memory and a processor. The memory has a computer program stored thereon, and when the processor executes the computer program, the following actions are implemented: when the loaded pixel data to be displayed includes pixel data corresponding to an image, dividing the image into a plurality of image blocks, and obtaining a color value of each pixel in each of the plurality of image blocks respectively.

In an embodiment, an electronic device is provided. The electronic device includes a memory and a processor. The memory has a computer program stored thereon, and when the processor executes the computer program, the following actions are implemented: in response to receiving pixel data to be displayed that is drawn by two or more mobile terminal applications, performing synthesis processing on the pixel data to be displayed that is drawn by each of the two or more mobile terminal applications, to obtain synthesized pixel data; and obtaining the color value of each pixel in the synthesized pixel data.

In an embodiment, a computer-readable storage medium is provided. The computer-readable storage medium has a computer program stored thereon, and when the computer program is executed by a processor, the following actions are implemented: obtaining a target brightness value, and a color value of each pixel in loaded pixel data to be displayed; adjusting the color value of each pixel based on the target brightness value, to obtain the adjusted color value; and performing error diffusion processing on the adjusted color value to obtain an error-diffusion processed color value, and displaying the loaded pixel data to be displayed by using the error-diffusion processed color value.

In an embodiment, a computer-readable storage medium is provided. The computer-readable storage medium has a computer program stored thereon, and when the computer program is executed by a processor, the following actions are implemented: obtaining the adjusted color value of the pixel and coordinate values of the pixel; processing the coordinate values of the pixel based on a triangular noise algorithm, to generate a quantization error corresponding to the pixel; and superimposing the quantization error on the adjusted color value of the pixel to obtain the error-diffusion processed color value of the pixel.

In an embodiment, a computer-readable storage medium is provided. The computer-readable storage medium has a computer program stored thereon, and when the computer program is executed by a processor, the following actions are implemented: splitting the color value of each pixel into corresponding red, green and blue color components; multiplying each of the red, green and blue color components of each pixel by the target brightness value, to obtain brightness-adjusted red, green and blue color components; and recombining the brightness-adjusted red, green and blue color components to obtain a brightness-adjusted color value.

In an embodiment, a computer-readable storage medium is provided. The computer-readable storage medium has a computer program stored thereon, and when the computer program is executed by a processor, the following actions are implemented: converting the color value of each pixel from a red, green and blue color space to a hue, saturation and brightness color space; multiplying a brightness component in a color space-converted color value of each pixel by the target brightness value, to obtain a brightness-adjusted color value of each pixel; and converting the brightness-adjusted color value of each pixel from the hue, saturation and brightness color space to the red, green and blue color space to obtain a brightness-adjusted color value of each pixel in the red, green and blue color space.

In an embodiment, a computer-readable storage medium is provided. The computer-readable storage medium has a computer program stored thereon, and when the computer program is executed by a processor, the following actions are implemented: when the loaded pixel data to be displayed includes pixel data corresponding to an image, dividing the image into a plurality of image blocks, and obtaining a color value of each pixel in each of the plurality of image blocks respectively.

In an embodiment, a computer-readable storage medium is provided. The computer-readable storage medium has a computer program stored thereon, and when the computer program is executed by a processor, the following actions are implemented: in response to receiving pixel data to be displayed that is drawn by two or more mobile terminal applications, performing synthesis processing on the pixel data to be displayed that is drawn by each of the two or more mobile terminal applications, to obtain synthesized pixel data; and obtaining a color value of each pixel in the synthesized pixel data.

Those of ordinary skill in the art can understand that all or some of the processes in the methods of the above embodiments can be implemented by instructing relevant hardware through a computer program, and the computer program can be stored in a non-volatile computer-readable storage medium. When the computer program is executed, it may include the processes of the above-mentioned method embodiments. Any reference to a memory, a storage, a database or other medium used in the various embodiments provided in the present disclosure may include a non-volatile and/or volatile memory. The non-volatile memory may include a read only memory (ROM), a programmable ROM (PROM), an electrically programmable ROM (EPROM), an electrically erasable programmable ROM (EEPROM), or a flash memory. The volatile memory may include a random-access memory (RAM) or an external cache memory. For the purpose of illustration and not for limitation, an RAM is available in various forms such as a static RAM (SRAM), a dynamic RAM (DRAM), a synchronous DRAM (SDRAM), a double data rate SDRAM (DDRSDRAM), an enhanced SDRAM (ESDRAM), a Synchlink DRAM (SLDRAM), a memory bus (Rambus) direct RAM (RDRAM), a direct memory bus dynamic RAM (DRDRAM), and a memory bus dynamic RAM (RDRAM), etc.

The technical features of the above embodiments can be combined arbitrarily. For the concise description, all possible combinations of the technical features in the above embodiments are not individually described. However, the combination of these technical features shall be considered to fall within the range described in this specification, unless contradiction occurs.

The above-mentioned embodiments are merely several representative embodiments of the present disclosure, and the specific and detailed descriptions thereof should not be construed as limitations on the scope of the present disclosure. It should be noted that, for those skilled in the art, without departing from the concept of the present disclosure, several modifications and improvements can be made, which all belong to the protection scope of the present disclosure. Therefore, the scope of protection of the present disclosure shall be defined by the appended claims.

What is claimed is:

1. A method for adjusting display brightness, comprising:
obtaining a target brightness value, and a color value of each pixel in loaded pixel data to be displayed;
adjusting the color value of each pixel based on the target brightness value, to obtain the adjusted color value; and
performing error diffusion processing on the adjusted color value to obtain an error-diffusion processed color value, and displaying the loaded pixel data to be displayed by using the error-diffusion processed color value.

2. The method according to claim 1, wherein said performing the error diffusion processing on the adjusted color value to obtain the error-diffusion processed color value comprises:
obtaining the adjusted color value of the pixel and coordinate values of the pixel;
processing the coordinate values of the pixel based on a triangular noise algorithm, to generate a quantization error corresponding to the pixel; and
superimposing the quantization error on the adjusted color value of the pixel, to obtain the error-diffusion processed color value of the pixel.

3. The method according to claim 1, wherein said adjusting the color value of each pixel, based on the target brightness value, to obtain the adjusted color value comprises:
converting the color value of each pixel from a red, green and blue color space to a hue, saturation and brightness color space;
multiplying a brightness component in a color space-converted color value of each pixel by the target brightness value, to obtain a brightness-adjusted color value of each pixel; and
converting the brightness-adjusted color value of each pixel from the hue, saturation and brightness color space to the red, green and blue color space, to obtain a brightness-adjusted color value of each pixel in the red, green and blue color space.

4. The method according to claim 1, wherein said obtaining the color value of each pixel in the loaded pixel data to be displayed comprises:
when the loaded pixel data to be displayed comprises pixel data corresponding to an image, dividing the image into a plurality of image blocks, and obtaining the color value of each pixel in each of the plurality of image blocks.

5. The method according to claim 1, further comprising, prior to said obtaining the color value of each pixel in the loaded pixel data to be displayed:
in response to receiving pixel data to be displayed that is drawn by two or more mobile terminal applications, performing synthesis processing on the pixel data to be displayed that is drawn by each of the two or more mobile terminal applications, to obtain synthesized pixel data,
wherein said obtaining the color value of each pixel in the loaded pixel data to be displayed comprises:
obtaining the color value of each pixel in the synthesized pixel data.

6. The method according to claim 1, wherein said adjusting the color value of each pixel based on the target brightness value, to obtain the adjusted color value comprises:
splitting the color value of each pixel into corresponding red, green and blue color components;
multiplying each of the red, green and blue color components of each pixel by the target brightness value, to obtain brightness-adjusted red, green and blue color components; and
recombining the brightness-adjusted red, green and blue color components to obtain a brightness-adjusted color value.

7. An electronic device, comprising:
a memory having a computer program stored thereon; and
a processor,
wherein the computer program, when being executed by the processor, implements a method for adjusting display brightness, the method comprising:
obtaining a target brightness value, and a color value of each pixel in loaded pixel data to be displayed;
adjusting the color value of each pixel based on the target brightness value, to obtain the adjusted color value; and
performing error diffusion processing on the adjusted color value to obtain an error-diffusion processed color value, and displaying the loaded pixel data to be displayed by using the error-diffusion processed color value.

8. The electronic device according to claim 7, wherein said performing the error diffusion processing on the adjusted color value to obtain the error-diffusion processed color value comprises:
obtaining the adjusted color value of the pixel and coordinate values of the pixel;
processing the coordinate values of the pixel based on a triangular noise algorithm, to generate a quantization error corresponding to the pixel; and
superimposing the quantization error on the adjusted color value of the pixel, to obtain the error-diffusion processed color value of the pixel.

9. The electronic device according to claim 7, wherein said adjusting the color value of each pixel, based on the target brightness value, to obtain the adjusted color value comprises:
converting the color value of each pixel from a red, green and blue color space to a hue, saturation and brightness color space;
multiplying a brightness component in a color space-converted color value of each pixel by the target brightness value, to obtain a brightness-adjusted color value of each pixel; and
converting the brightness-adjusted color value of each pixel from the hue, saturation and brightness color space to the red, green and blue color space, to obtain a brightness-adjusted color value of each pixel in the red, green and blue color space.

10. The electronic device according to claim 7, wherein said obtaining the color value of each pixel in the loaded pixel data to be displayed comprises:
when the loaded pixel data to be displayed comprises pixel data corresponding to an image, dividing the image into a plurality of image blocks, and obtaining the color value of each pixel in each of the plurality of image blocks.

11. The electronic device according to claim 7, wherein the method for adjusting display brightness further comprises, prior to said obtaining the color value of each pixel in the loaded pixel data to be displayed:
in response to receiving pixel data to be displayed that is drawn by two or more mobile terminal applications, performing synthesis processing on the pixel data to be displayed that is drawn by each of the two or more mobile terminal applications, to obtain synthesized pixel data,
wherein said obtaining the color value of each pixel in the loaded pixel data to be displayed comprises:
obtaining the color value of each pixel in the synthesized pixel data.

12. The electronic device according to claim 7, wherein said adjusting the color value of each pixel based on the target brightness value, to obtain the adjusted color value comprises:
splitting the color value of each pixel into corresponding red, green and blue color components;
multiplying each of the red, green and blue color components of each pixel by the target brightness value, to obtain brightness-adjusted red, green and blue color components; and
recombining the brightness-adjusted red, green and blue color components to obtain a brightness-adjusted color value.

13. A computer-readable storage medium, having a computer program stored thereon, wherein the computer program, when being executed by a processor, implements a method for adjusting display brightness, the method comprising:
obtaining a target brightness value, and a color value of each pixel in loaded pixel data to be displayed;
adjusting the color value of each pixel based on the target brightness value, to obtain the adjusted color value; and
performing error diffusion processing on the adjusted color value to obtain an error-diffusion processed color value, and displaying the loaded pixel data to be displayed by using the error-diffusion processed color value.

14. The computer-readable storage medium according to claim 13, wherein said performing the error diffusion processing on the adjusted color value to obtain the error-diffusion processed color value comprises:
obtaining the adjusted color value of the pixel and coordinate values of the pixel;
processing the coordinate values of the pixel based on a triangular noise algorithm, to generate a quantization error corresponding to the pixel; and
superimposing the quantization error on the adjusted color value of the pixel, to obtain the error-diffusion processed color value of the pixel.

15. The computer-readable storage medium according to claim 13, wherein said adjusting the color value of each pixel, based on the target brightness value, to obtain the adjusted color value comprises:
converting the color value of each pixel from a red, green and blue color space to a hue, saturation and brightness color space;
multiplying a brightness component in a color space-converted color value of each pixel by the target brightness value, to obtain a brightness-adjusted color value of each pixel; and
converting the brightness-adjusted color value of each pixel from the hue, saturation and brightness color space to the red, green and blue color space, to obtain a brightness-adjusted color value of each pixel in the red, green and blue color space.

16. The computer-readable storage medium according to claim 13, wherein said obtaining the color value of each pixel in the loaded pixel data to be displayed comprises:
when the loaded pixel data to be displayed comprises pixel data corresponding to an image, dividing the image into a plurality of image blocks, and obtaining the color value of each pixel in each of the plurality of image blocks.

17. The computer-readable storage medium according to claim 13, wherein the method for adjusting display brightness further comprises, prior to said obtaining the color value of each pixel in the loaded pixel data to be displayed:
in response to receiving pixel data to be displayed that is drawn by two or more mobile terminal applications, performing synthesis processing on the pixel data to be displayed that is drawn by each of the two or more mobile terminal applications, to obtain synthesized pixel data,
wherein said obtaining the color value of each pixel in the loaded pixel data to be displayed comprises:
obtaining the color value of each pixel in the synthesized pixel data.

18. The computer-readable storage medium according to claim 13, wherein said adjusting the color value of each pixel based on the target brightness value, to obtain the adjusted color value comprises:
splitting the color value of each pixel into corresponding red, green and blue color components;
multiplying each of the red, green and blue color components of each pixel by the target brightness value, to obtain brightness-adjusted red, green and blue color components; and
recombining the brightness-adjusted red, green and blue color components to obtain a brightness-adjusted color value.
